(19) United States
(12) Patent Application Publication
(10) Pub. No.: US 2015/0220200 A1
(43) Pub. Date: Aug. 6, 2015

(54) Touch Panel And Touch Screen Having The Same

(71) Applicant: DONGBU HITEK CO., LTD., Seoul (KR)

(72) Inventor: Kwang Hyun Kim, Gyeonggi-do (KR)

(21) Appl. No.: 14/300,934

(22) Filed: Jun. 10, 2014

(30) Foreign Application Priority Data
Feb. 4, 2014 (KR) 10-2014-0012769

(51) Int. Cl. G06F 3/041; G06F 3/044

(52) U.S. Cl. CPC G06F 3/0416; G06F 3/0412; G06F 3/0418; G06F 3/044

(57) ABSTRACT

Disclosed is a touch panel for recognizing touch of a conductor and a touch screen including the same. The touch panel includes a driving line extending in a first direction, and a sensing line disposed over the driving line to extend in a second direction crossing the first direction. The driving line has one or more holes that are formed in both sides of a region in which the driving line and the sensing line overlap each other. The driving line comprises a noise blocking pattern corresponding to a bottom surface of the sensing line in the overlapping region.

### CROSS-REFERENCE TO RELATED APPLICATION

This application claims priority to Korean Patent Application No. 10-2014-0012769, filed on Feb. 4, 2014 and all the benefits accruing therefrom under 35 U.S.C. §119, the contents of which are incorporated by reference in their entirety.

### BACKGROUND

The present disclosure relates to a touch panel and touch screen which are reduced in thickness and increased in mutual capacitance to improve touch performance.

In general, touch panels through which a user directly contacts a screen by using a finger or pen to input information may be used as input device for personal computers, mobile communication devices, and other private information processing devices.

Touch panels offer several advantages over other input methods. For example, touch panels typically have fewer malfunctions, are easily portable, character input is enabled without requiring the use of other input devices, and input methods are cleared defined for users. Thus, touch panels may be applicable to various information processing devices in recent years.

Touch panels may be classified into various types according to the method of detecting user touch input. For example, these types may include ultrasonic touch panels, electrostatic capacitive touch panels, resistive touch panels, electromagnetic touch panels, and optical sensor touch panels.

Resistive touch panels may function by detecting a voltage gradient caused by resistance that varies when touched by the user. This resistance is measured to determine a touched position. As a result, an analog-to-digital converter is needed to convert the analog resistance measurement to a digital reading. Thus, if the resistance cannot be clearly measured, the touch panel may have difficulty in providing accurate touch readings.

In the case of the optical sensor touch panels, it may be difficult to determine a touched position when an optical path between an optical output device and an optical input device is blocked.

Electromagnetic touch panels may use principles of electromagnetic force to detect touch locations. For example, a separate stylus pen incorporating an electromagnetic coil may be required to provide input to such devices.

In the case of the ultrasonic touch panels, it may be difficult to determine a touched position when a sound path between a sound output device and a sound input device is blocked. Thus, the ultrasonic type may be vulnerable to surrounding noises.

When compared to the above-described touch types, electrostatic capacitive touch panels may provide an advantage in that such panels may have strong impact resistance and less affected by ambient noise. Thus, the electrostatic capacitive touch panels are increasing in popularity.

Such touch panels are typically implemented using mutual capacitance techniques. Mutual capacitance touch panels may be implemented by a technique in which a conductive layer constituting a touch panel has equipotentiality to sense a capacitance value that varies on a top surface thereof when a conductor contacts thereon, thereby recognizing a touch input by user. That is, in the mutual capacitance type touch panel, a driving line that is an X-axis electrode row and a sensing line that is a Y-axis electrode row may cross each other to form a matrix form, and then, when a specific position on the matrix form is touched, mutual capacitance that varies at the specific position may be measured to sense a touched position. Thus, when the mutual capacitance that varies when touched by the conductor increases, touch sensitivity may be improved.

In recent years, miniaturization of mobile devices incorporating touch screen technology has become increasingly important. Similarly, it has become more and more important to minimize the profile thickness of such devices. However, when the touch panel is reduced in thickness, a distance between the driving line and the sensing line may be reduced. Thus, a variation in the mutual capacitance may be reduced, thereby reducing touch sensitivity.

### SUMMARY

The present disclosure provides a touch panel and touch screen which provide a reduced thickness, improved touch sensitivity, and strong noise-resistance.

In accordance with an exemplary embodiment, a touch panel for recognizing touch of a conductor may include a driving line extending in a first direction, and a sensing line disposed over the driving line to extend in a second direction crossing the first direction. The driving line defines one or more holes that are formed in both sides of a region in which the driving line and the sensing line overlap each other. The driving line includes a noise blocking pattern corresponding to a bottom surface of the sensing line in the overlapping region.

Each of the one or more holes may have a width of approximately 200 μm.

The sensing line may include a main line extending in the second direction, a sub line spaced a predetermined distance from a side of the main line to extend in the second direction, and a branch line connecting the main line with the sub line.

The noise blocking pattern may include a first noise blocking pattern corresponding to the main line, a second noise blocking pattern corresponding to the sub line, and a third noise blocking pattern corresponding to the branch line, and the one or more holes may be formed in both sides of the first, second, and third noise blocking patterns.

The driving line may include a bridge pattern connecting a region that is isolated by the holes with at least one of the first, second, and third noise blocking patterns.

At least one of the first, second, and third noise blocking patterns may be electrically isolated from the driving line and electrically grounded through a ground line.

The touch panel may further include a driving part for applying a driving signal to the driving line and a sensing part for detecting mutual capacitance varying by the touch to calculate a touch coordinate.

In accordance with another exemplary embodiment, a touch screen for recognizing touch of a conductor and outputting an image may include a display, a driving line disposed over the display to extend in a first direction, and a sensing line disposed over the driving line to extend in a second direction crossing the first direction. The driving line defines one or more holes that are formed in both sides of a region in which the driving line and the sensing line overlap each other. The driving line includes a noise blocking pattern corresponding to a bottom surface of the sensing line in the overlapping region.

An optical clear adhesive layer may be disposed between the driving line and the sensing line.

The sum of thicknesses of the driving line, the optical clear adhesive layer and the sensing line may be less than approximately 40 μm.

The optical clear adhesive layer may include an insulation material.

In accordance with still another exemplary embodiment, a touch panel for recognizing a touch of a conductor may include a driving line extending in a first direction, and a sensing line disposed over the driving line to extend in a second direction crossing the first direction. The driving line includes a ground pattern disposed in a region in which the driving line and the second line overlap each other, and at least one hole may be formed to surround the ground pattern.

The touch panel may further include a ground line connected with the ground pattern, the ground line electrically grounding the ground pattern.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Exemplary embodiments can be understood in more detail from the following description taken in conjunction with the accompanying drawings which are not necessarily drawn to scale, in which:

FIG. 1 is a cross-sectional view of a touch screen in accordance with an exemplary embodiment;

FIG. 2 is a plan view of the touch screen in accordance with an exemplary embodiment;

FIG. 3A is a view illustrating a state in which capacitive coupling occurs between a driving line and a sensing line when driving current flows into the driving line without being touched, and FIG. 3B is a view illustrating a state in which mutual capacitance varies when touched;

FIG. 4 is a perspective view illustrating patterns of a driving line and a sensing line in a single pixel in accordance with a first embodiment;

FIG. 5 is a plan view illustrating a pattern of the driving line in the single pixel in accordance with the first embodiment;

FIG. 6 is a plan view of a sensing line including a sub line and branch line in a single pixel in accordance with a second embodiment;

FIG. 7 is a plan view of a driving line corresponding to the sensing line of FIG. 6 in accordance with the second embodiment;

FIG. 8 is a plan view illustrating a pattern of a sensing line in a single pixel in accordance with a third embodiment;

FIG. 9 is a plan view illustrating a pattern of a driving line corresponding to the sensing line of FIG. 8 in accordance with the third embodiment;

FIG. 10 is a plan view illustrating a pattern of a driving line in a single pixel in accordance with a fourth embodiment;

FIG. 11 is a plan view of the driving line and a sensing line in the single pixel in accordance with the fourth embodiment;

FIG. 12 is a plan view of driving lines and sensing lines in a plurality of pixels of FIG. 11 in accordance with the fourth embodiment;

FIG. 13 is a view for explaining a variation in mutual capacitance when a specific position on a touch panel is touched in accordance with the third embodiment; and

FIG. 14 is a view for explaining a variation in mutual capacitance when a touch pattern traveling in a diagonal direction is inputted on the touch panel in accordance with the third embodiment.

### DETAILED DESCRIPTION OF EMBODIMENTS

Hereinafter, specific embodiments will be described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the inventive concept to those skilled in the art.

It will also be understood that when an element or layer is referred to as being ‘on’ another element or layer, it can be directly on the other element or layer, or one or more intervening elements or layers may also be present. On the other hand, it will be understood that when an element is directly disposed on or connected to another one, further another element can not be present therebetween. Also, though terms like a first, a second, and a third are used to describe various elements, compositions, areas and/or layers in various embodiments of the inventive concept, the elements, compositions, areas and/or layers are not limited to these terms.

In the following description, certain technical terms are used only for explaining specific exemplary embodiments; such terms are not intended to limit the present disclosure. Also, unless otherwise defined, all terms, including technical and scientific terms used herein have the same meaning as commonly understood by one of ordinary skill in the art to which the invention pertains. Some embodiments of the invention are described with reference to the schematic diagrams illustrated. Accordingly, deviations from these schematic diagrams are to be expected in accordance with expected production methods and tolerances. Thus, illustrations of embodiments of the invention may be described with respect to particular portions of devices, processes, and the like incorporating said embodiments, and it should be understood that such embodiments may include other features not explicitly shown in the illustrations. Furthermore, such illustrations may not be drawn to scale, and the size, shape, and other measurements of features in the illustrations is not intended to limit the scope of the claimed invention.

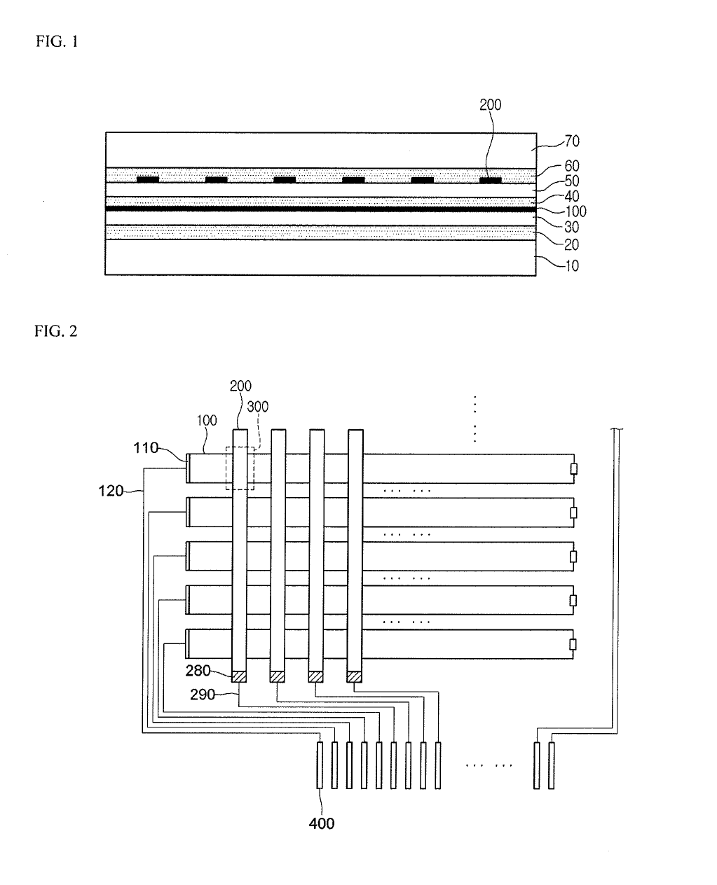

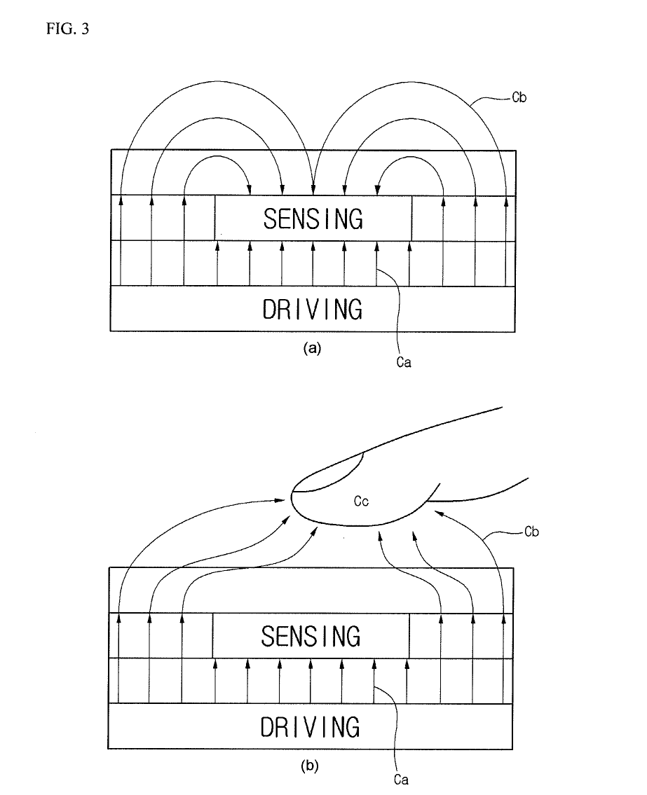

FIG. 1 is a cross-sectional view of a touch screen in accordance with an exemplary embodiment, and FIG. 2 is a plan view of the touch screen in accordance with an exemplary embodiment. Hereinafter, structures of a touch panel and touch screen will be described with reference to FIGS. 1 and 2. Although a touch screen panel display device illustrated in FIG. 2 is provided as a Glass Film Film (GFF) type, embodiments of the invention may be applied to various other electrostatic capacitive type touch panels such as a film electrode or glass type touch panel.

Referring to FIG. 1, a touch screen panel display device includes a display 10, an X-axis Indium Tin Oxide (ITO) film 30 stacked on the display 10, driving lines 100 including a plurality of electrodes that extend in an X-axis direction (a first direction) on a top surface of the X-axis ITO film 30, a Y-axis ITO film 50 stacked on the X-axis film 30 and the driving lines 100, sensing lines 200 including a plurality of electrodes that extend in a Y-axis direction (a second direction) on a top surface of the Y-axis ITO film 50, and a window glass 70 stacked on the Y-axis ITO film 50 and the sensing lines 200.

Optical clear adhesive layers 20, 40, and 60 may be disposed between the display 10 and the X-axis ITO film 30, between the X-axis ITO film 30 and the Y-axis ITO film 50, and between the Y-axis ITO film 50 and the window glass 70, respectively.

In the touch screen panel, a touch panel type in which each of the intermediate adhesive layer 40 and the X-axis and Y-axis ITO films 30 and 50 is reduced in thickness by approximately half or more compared to a standard GFF panel may be known as a slim GFF type.

For example, in the general GFF type touch screen panel, the sum of thicknesses of the X-axis ITO film 30, the intermediate adhesive layer 40, and the Y-axis ITO film 50 may range from approximately 150 μm to approximately 200 μm. In the slim GFF type touch screen panel, the sum of thicknesses of the X-axis ITO film 30, the intermediate adhesive layer 40, and the Y-axis ITO film 50 may be approximately 40 μm or less.

Particularly, when the intermediate adhesive layer 40 includes an insulation material, the sum of thicknesses of the X-axis ITO film 30, the intermediate adhesive film 40, and the Y-axis ITO film 50 may be approximately 20 μm or less.

Hereinafter, the touch panel will be described in more detail with reference to FIG. 2. The touch panel illustrated in FIG. 2 may have a grid or matrix form. For example, the touch panel may include the driving lines 100 including the plurality of electrodes that extend in the X-axis direction and are arranged in the Y-axis direction and the sensing lines 200 that extend in the Y-axis direction to cross the driving lines 100 over horizontal top surfaces of the driving lines 100 and are arranged in the X-axis direction. Coordinates of the touch panel may be defined by the driving lines 100 and the sensing lines 200.

The driving lines 100 may be transparent electrodes each of which has a bar shape with a predetermined width. The driving lines 100 are spaced apart from each other in the Y-axis direction by a predetermined distance to be arranged in rows. Each of the driving lines 100 may have one end on which a first contact part 110 is provided. The first contact part 110 may be connected to a driving part (not shown) through one of first trace lines 120 that are disposed on each of an outer portion of the touch panel and ports 400 respectively connected to the first trace lines 120. The driving part may apply a driving signal to the driving lines 100 to induce capacitive coupling between the driving lines 100 and the sensing lines 200.

When the driving lines 100 extend in the X-axis direction, the sensing lines 200 may extend in the Y-axis direction on the driving lines 100 to cross the driving lines 100 at right angles and the driving lines 100 and the sensing lines 200 are disposed on different planes. The sensing lines 200 may be transparent electrodes each of which has a bar shape with a predetermined width. The sensing lines 200 are spaced apart from each other in the X-axis direction by a predetermined distance to be arranged in columns. It should be appreciated that although some exemplary embodiments described herein relate to an “X-axis” and a “Y-axis”, it should be appreciated that alternative embodiments may reverse the relative positioning of these axes with respect to other elements of the device. Each of the sensing lines 200 has one end on which a second contact part 280 is provided. The second contact part 280 may be connected to a sensing part (not shown) through one of second trace lines 290 and one of the ports 400 that are disposed on an outer portion of the touch panel.

The sensing part may measure mutual capacitance that varies by touch of a conductor to calculate a coordinate of a touch point, at which the mutual capacitance varies, as a touched portion. For example, when the driving part applies a driving signal to a specific one of the driving lines 100, if a specific point on the specific one of the driving lines 100 is touched, mutual capacitance of the sensing lines 200 disposed around the touched point may vary. The sensing part may calculate a Y-axis coordinate from the sensing lines 200 of which mutual capacitance varies and recognize the specific one of the driving lines 100 to which the driving signal is applied. This specific one of the driving lines 100 may be recognized as an X-axis coordinate to calculate a touch coordinate. As illustrated in FIG. 2, when points at which the driving lines 100 and the sensing lines 200 cross each other are defined as pixels 300, if a specific pixel 300 is touched, mutual capacitance may vary at the specific pixel 300. Thus, the sensing part may sense a position of the specific pixel 300 to calculate a touch coordinate. As described above, a method in which X-axis and Y-axis points of the pixel 300 at which the mutual capacitance varies are calculated as a touch coordinate to recognize user's touch may be called a mutual capacitance method.

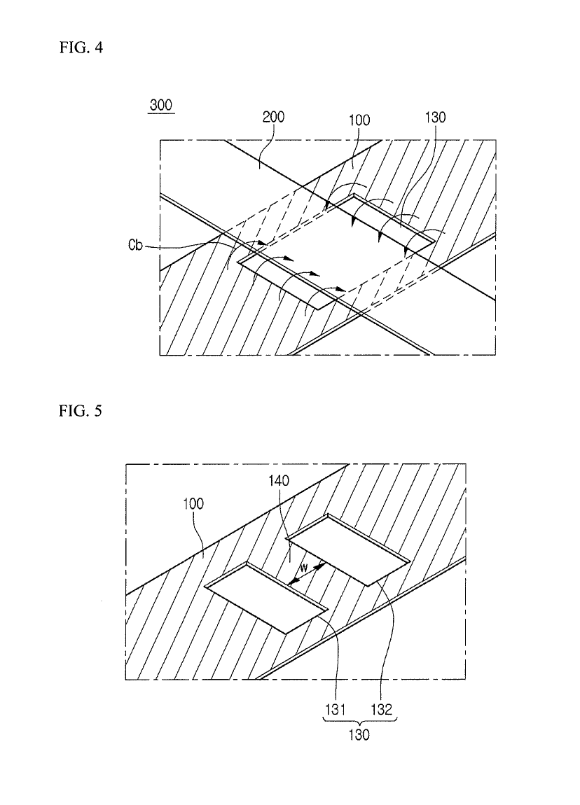

Hereinafter, variation in mutual capacitance will be described in detail with reference to FIG. 3. FIG. 3A is a view illustrating a state in which capacitive coupling occurs between the driving line and the sensing line when driving current flows into the driving line without being touched, and FIG. 3B is a view illustrating a state in which mutual capacitance varies when touched.

Referring to FIG. 3A, the mutual capacitance may be classified into parasitic capacitance Ca occurring in an area on which one of the driving lines 100 and one of the sensing lines 200 overlap each other and fringing capacitance Cb occurring at a fringe of one of the sensing lines 200 that does not overlap one of the driving lines 100.

Also, referring to FIG. 3B, when a hand corresponding to the conductor is touched, the mutual capacitance between the sensing line 200 and the driving line 100 may vary. In more detail, a portion of the fringing capacitance Cb occurring at the fringe of one of the sensing lines 200 may be coupled to a hand, thereby reducing an amount of mutual capacitance.

A method for detecting a touch input may include determining a coordinate of the touch input by measuring a variance in mutual capacitance as described above. Particularly, since an amount of fringing capacitance Cb is proportional to variation in mutual capacitance, as the fringing capacitance Cb increases, touch sensitivity may increase.

However, when each of the sensing lines 200 and the driving lines 100 has a bar type structure with a relatively wide width, the parasitic capacitance Ca may be greater than the fringing capacitance Cb because of the wide overlapping area therebetween. Thus, the mutual capacitance may be reduced in variation by the parasitic capacitance.

When a distance between one of the driving lines 100 and one of the sensing lines 200 is reduced, the parasitic capacitance Ca may increase. On the other hand, the fringing capacitance Cb may decrease. This reduction in the fringing capacitance may cause a significant reduction in the variation in mutual capacitance.

For example, in case of the slim GFF touch panel, the shorter the distance between one of the sensing lines 200 and one of the driving lines 100, the more the fringing capacitance Cb decreases and the parasitic capacitance Ca increases. As a result, the touch sensitivity of the touch panel may be significantly reduced.

Thus, a touch panel structure with a reduced thickness that still increases the variance of the mutual capacitance when the conductor is touched is desirable.

The present disclosure includes embodiments in which the mutual capacitance increases in variation through various changes in structure of the touch panel. Thus, in the following description, a description overlapping with the foregoing embodiment will be omitted in the interest of clarity and conciseness. Although only the patterns of one of the driving lines 100 and one of the sensing lines 200 in the specific pixel 300 are described for convenience of description, the descriptions with respect to the specific pixel 300 may be applied to the whole pixels 300.

### First Embodiment

FIG. 4 is a perspective view illustrating patterns of a driving line and a sensing line in a single pixel in accordance with a first embodiment, and FIG. 5 is a plan view illustrating a pattern of the driving line in the single pixel in accordance with the first embodiment.

Referring to FIG. 4, the pixel 300 includes a driving line 100 having a hole 130 for increasing a fringing capacitance Cb and a sensing line 200 disposed over the driving line 100 to cross the driving line 100. Here, a distance between the driving line 100 and the sensing line 200 may be an approximately 40 μm or less. In this context, the term “approximately” should be understood to relate to manufacturing and/or operational tolerances that serve to maintain sufficient functionality to derive the expected benefits of the present invention.

However, if the driving line 100 and the sensing line 200 are too close to each other, the fringing capacitance Cb may be relatively reduced. Thus, it may be difficult to calculate a touch coordinate.

In accordance with an exemplary embodiment, the hole 130 for relatively increasing the fringing capacitance Cb may be formed in an area in which the driving line 100 and the sensing line 200 overlap each other. Here, the overlapping area may represent a portion of an area of the driving line 100 that perpendicularly corresponds to the sensing line 200.

For example, a square hole 130 having an area greater than the width of the sensing line 200 in both directions by approximately 200 μm is formed in the driving line 100 as shown in FIG. 4. Thus, capacitive coupling may effectively occur between the driving line disposed around the hole 130 and the sensing line 200 disposed over the hole 130.

That is, when the driving line 100 and the sensing line 200 are spaced apart from each other by approximately 200 μm, the fringing capacitance Cb may have the largest value compared to other capacitances (e.g., the parasitic capacitance). Thus, the hole 130 may have a size determined so that the shortest distance between the driving line 100 and the sensing line 200, which are disposed around the hole 130, is approximately 200 μm. However, when the driving line 100 is formed as illustrated in FIG. 4, a bottom surface of the sensing line 200 may be exposed to a display 10 through the hole 130.

For example, a signal generated in the display 10 as shown in FIG. 1 may be introduced into the sensing line 200 as noises through the hole 130. Thus, a sensing part may have difficulty in calculating of the touch coordinate. To prevent the above-described phenomenon, a noise blocking pattern may be further disposed in the hole 130.

Referring to FIG. 5, a noise blocking pattern 140 corresponding to the bottom surface of the sensing line 200 may be disposed in the hole 130 of the driving line 100. For example, a first hole 131 having a width of approximately 200 μm to the left of the area on which the driving line 100 overlaps the sensing line 200 and a second hole 132 having a width of approximately 200 μm to the right may be formed in the driving line 100. The noise blocking pattern 140 may be disposed between the first hole 131 and the second hole 132.

Since the noise blocking pattern 140 blocks a space between the bottom surface of the sensing line 200 and the display, the sensing line 200 may not be directly exposed to the display 10, thereby reducing an inflow rate of noise and/or other interference. In addition, a sufficient distance for the coupling of the fringing capacitance Cb may be secured through the first and second holes 131 and 132.

That is, in some embodiments, the hole 130 may be provided in the driving line 100 to increase the fringing capacitance Cb, and also the noise blocking pattern 140 may be disposed in the hole 130 to prevent noise or other interference from being introduced into the sensing line 200.

This structure may be applied to the touch panels having various structures. Hereinafter, the sensing line 200 and the driving line 100 which have various patterns will be described.

### Second Embodiment

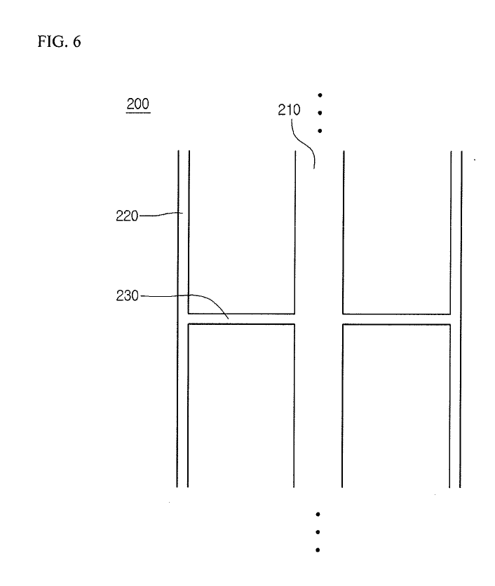

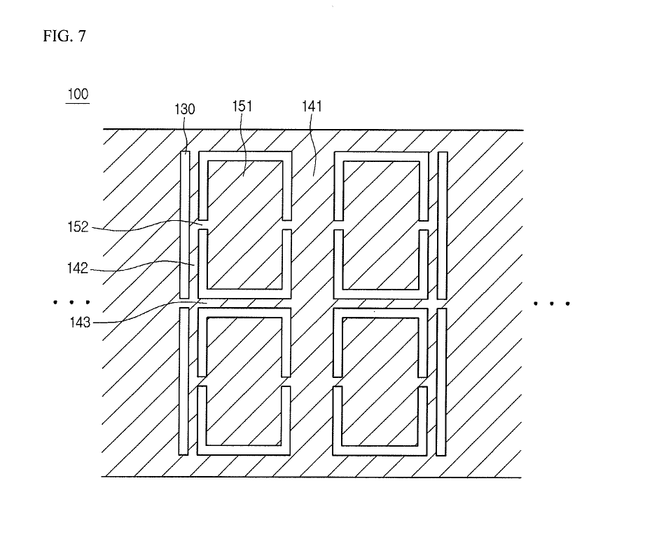

FIG. 6 is a plan view of a sensing line including a sub line and branch line in a single pixel in accordance with a second embodiment, and FIG. 7 is a plan view of a driving line corresponding to the sensing line of FIG. 6 in accordance with the second embodiment.

Referring to FIG. 6, a sensing line 200 may include a main line 210, at least one sub line 220, and at least one branch line 230. The main line 210 may be a transparent electrode having a bar shape to extend in a Y-axis direction.

The sub line 220 may be a bar-shaped transparent electrode that is disposed spaced a predetermined distance from a side of the main line 210 to extend in the Y-axis direction. For another example, as illustrated in FIG. 6, sub lines 220 may be disposed on both sides of the main line.

The sub line 220 may have a width less than that of the main line 210. For example, when the main line 210 has a width of approximately 600 μm, the sub line 220 may be a width of approximately 150 μm that corresponds to a quarter of the width of the main line 210.

The branch line 230 may be a transparent electrode that protrudes from a side surface of the main line 210 to extend up to the sub line 220. That is, the branch line 230 may connect the main line 210 with the sub line 220.

The branch line 230 may be disposed in a direction crossing the main line 210 and the sub line 220 to connect the main line 210 with the sub line 220 at the shortest distance between the main line 210 and the sub line 220. Here, the branch line 230 may have a width of approximately 300 μm, corresponding to half of that of the main line 210.

A plurality of the branch lines 230 may be provided. For example, the branch lines 230 may include a first branch line connecting an upper portion of the main line 210 to an upper portion of the sub line 220 and a second branch line connecting a lower portion of the main line 210 to a lower portion of the sub line 220.

As a result, the sensing line 200 may increase in circumferential length, and thus, the fringing capacitance may increase in promotional to the increasing length, thereby improving touch sensitivity. Also, when the touch position moves from the main line 210 toward the sub line 220, mutual capacitance of a pixel 300 may be linearly reduced to thereby accurately detect the touch position.

However, if a distance between the driving line 100 and the sensing line 200 is excessively narrow, a sufficient amount of fringing capacitance may not be measured even though the circumferential length increases. Thus, it may be necessary that a pattern of the driving line 100 is changed according to a pattern of the sensing line 200.

Referring to FIG. 7, the driving line 100 corresponding to the pattern of the sensing line 200 may include noise blocking patterns 141, 142, and 143 and holes 130 for improving the fringing capacitance.

In more detail, the driving line 100 may be a bar-type transparent electrode. Also, the driving line 100 may be spaced by a predetermined distance downward from the sensing line 200. Also, the driving line 100 may extend in a direction (e.g., an X-axis direction) crossing the main line 210.

Holes 130 may be formed around an area on which the driving line 100 and the sensing line 200 overlap each other. Each of the holes 130 may have a predetermined width to improve the fringing capacitance. The noise blocking patterns 141, 142, and 143 may be disposed on the area on which the driving line 100 overlaps the sensing line 200. Particularly, the noise blocking patterns 141, 142, and 143 may correspond to the main line 210, the sub line 220, and the branch line 230, respectively. For example, the holes 130 each of which has a width of approximately 200 μm to surround the noise blocking patterns 141, 142, and 143 may be formed.

A portion 151 of an area of the driving line 100 may be electrically isolated by the holes 130. In accordance with an exemplary embodiment, the driving line 100 may include a bridge pattern 152 connecting the portion 151 that is electrically isolated with at least one of the noise blocking patterns 141, 142, and 143.

In summary, the driving line 100 may include the noise blocking patterns 141, 142, and 143 that respectively correspond to the main line 210, the sub line 220, and the branch line 230 of the sensing line 200 and the holes 130 defined around the noise blocking patterns 141, 142, and 143. Thus, the fringing capacitance Cb may be relatively increased, and the noise may be prevented from being introduced from the display 10.

However, although the touch pattern moving in the X-axis direction and the touch pattern moving in the Y-axis direction in the pattern of the sensing line 200 are accurately sensed, it may be difficult to sense the touch pattern moving in a diagonal direction with respect to the X-axis and Y-axis directions.

### Third Embodiment

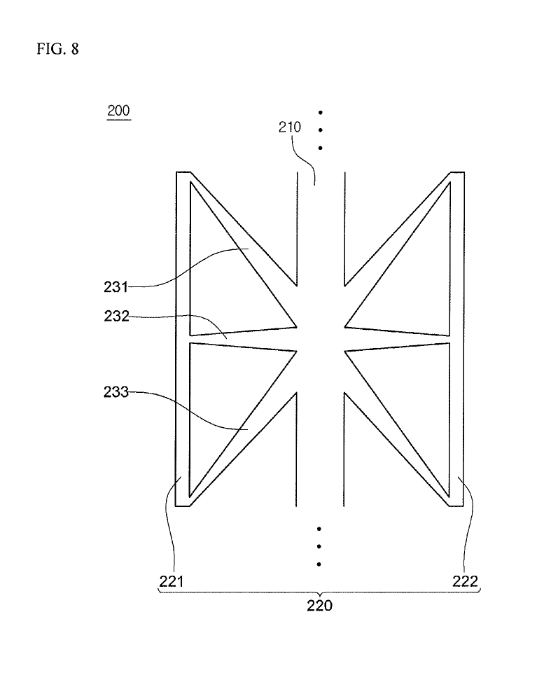

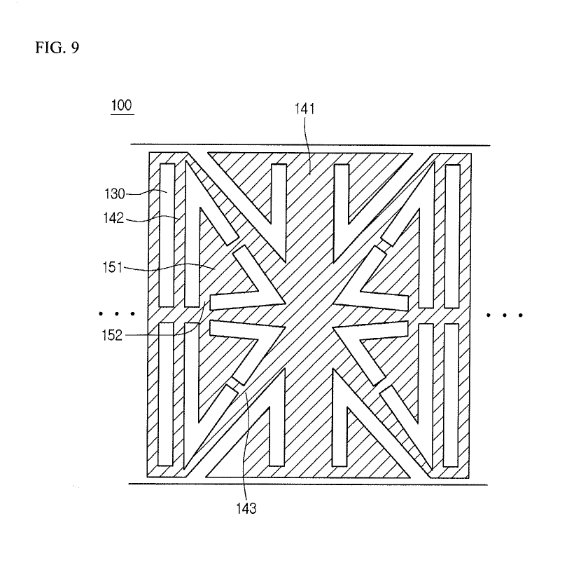

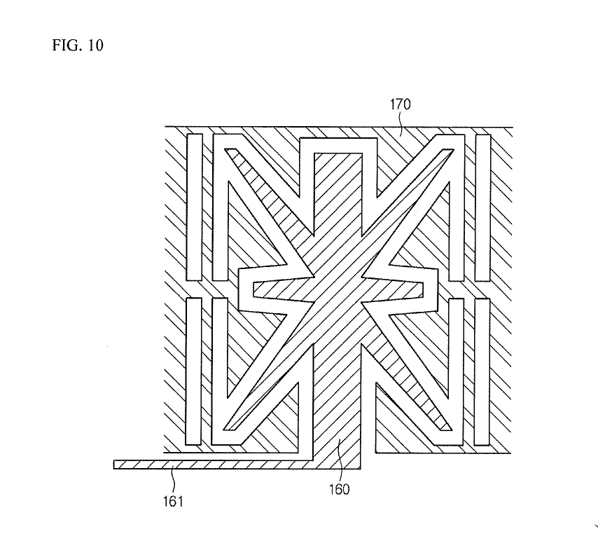

FIG. 8 is a plan view illustrating a pattern of a sensing line in a single pixel in accordance with a third embodiment, and FIG. 9 is a plan view illustrating a pattern of a driving line corresponding to the sensing line of FIG. 8 in accordance with the third embodiment.

Referring to FIG. 8, a sensing line 200 may include a main line 210, a sub line 220, and a branch line 230. Particularly, the main line 210 may be a transparent electrode having a bar shape to extend in a Y-axis direction. Also, the main line 210 may be connected to main lines of other pixels adjacent in the Y-axis direction.

Also, sub lines 220 spaced a predetermined distance from each other are disposed on both sides of the main line 210, and branch lines 230 connecting the main line 210 with the sub lines 220 are provided.

For example, a first sub line 221 spaced a predetermined distance from the main line 210 in a left direction and a second sub line 222 spaced a predetermined distance from the main line 210 in a right direction may be provided. Each of the sub lines 220 may have a width less than that of the main line 210. Also, unlike the main line 210, the sub lines 220 may not be connected to the sub lines 220 of other pixels 300 adjacent in the Y-axis direction.

Also, a second branch line 232 extending in an X-axis direction to connect a central portion of the main line 210 with the sub lines 220 and first and third branch lines 231 and 233 extending from the central portion of the main line 210 in diagonal directions with respect to the X-axis and Y-axis directions to connect the central portion of the main line 210 with the sub lines 220 may be provided.

The first, second, and third branch lines 231, 232 and 233 may be disposed within a pixel area and have widths gradually decreasing in a direction that is away from the main line 210. For example, when the main line 210 has a width of approximately 600 μm, each of the sub lines 220 may be a width of approximately 150 μm, corresponding to a quarter of the width of the main line 210. Also, one end of each of the first, second, third branch lines 231, 232 and 233 connected to the main line 210 may have a width of approximately 300 μm that corresponds to a half of that of the main line 210. The other end of each of the first, second, and third branch lines 231, 232, and 233 connected to the sub lines 220 may have a width of approximately 80 μm, corresponding to two fifteenths of the main line 210.

Here, the pixel area may represent an area within a boundary between a specific pixel 300 and other pixels 300 disposed around the specific pixel 300. In the pixel 300 having the above-described structure, a circumference of the sensing line 200 may be increased in length to increase fringing capacitance. Also, since each of the branch lines 213, 232, and 233 decreases in width in directions that are away from the central portion of the main line 210, and the sub line 220 has a width less than that of the main line 210, the mutual capacitance may be linearly reduced in the directions in which the touch point is away from a central portion of the pixel area.

Hereinafter, the driving line 100 corresponding to the sensing line 200 of FIG. 8 will be described in more detail with reference to FIG. 9. The driving line 100 may include noise blocking patterns 141, 142, 143 that respectively correspond to the main line 210, the sub line 220, and the branch lines 231, 232, and 233 of the sensing line 200. Also, the driving line 100 may have holes 130 defined around the noise blocking patterns 141, 142, and 143.

The driving line 100 may be a bar-type transparent electrode. The driving line 100 may be disposed to be spaced a predetermined distance downward from the sensing line 200. The driving line 100 may extend in a direction (e.g., an X-axis direction) crossing the main line 210.

The holes 130, each of which has a predetermined width to improve the fringing capacitance, may be defined around an area on which the driving line 100 and the sensing line 200 overlap each other. The noise blocking patterns 141, 142, and 143 may be disposed on the area on which the driving line 100 overlaps the sensing line 200. Particularly, the noise blocking patterns 141, 142, and 143 may correspond to the main line 210, the sub line 220, and the branch lines 231, 232, and 233, respectively.

The holes 130 may be defined to each have a width of approximately 200 μm to surround the noise blocking patterns 141, 142, and 143.

A portion 151 of an area of the driving line 100 may be electrically isolated by the holes 130. In accordance with an exemplary embodiment, the driving line 100 may include a bridge pattern 152 connecting the portion 151 that is electrically isolated to at least one of the noise blocking patterns 141, 142, and 143.

In summary, the driving line 100 may include the noise patterns 141, 142, and 143 that respectively correspond to the main line 210, the sub line 220, and the branch lines 231, 232, and 233 of the sensing line 200 and the holes 131 formed around the noise blocking patterns 141, 142, and 143. Thus, the fringing capacitance Cb may relatively increase, and the noise may be prevented from being introduced from the display 10.

Since the noise blocking patterns 141, 142, and 143 are only concerned in coupling of parasitic capacitance Ca, it is unnecessary for the noise blocking patterns 141, 142, and 143 to be connected to the driving line 100 that a driving signal is received.

### Fourth Embodiment

As described above, introduction of the noise blocking patterns described in the first, second, and third embodiments may be concerned primarily with the coupling of the parasitic capacitance. Meanwhile, in accordance with the first, second, and third embodiments, when the driving signal is applied to the driving line 100, the other driving lines may be grounded. In this case, the other driving lines except for the driving line 100 to which the driving signal is applied may block introduction of noises into the sensing line 200 due to a noise shielding effect of the ground.

However, the shielding of noise may be limited in the driving line 100 itself to which the driving signal is applied, since the driving signal is applied to the noise blocking patterns.

In some embodiments, to overcome the above-described limitation, a ground pattern is inserted into an area on which the driving line and the sensing line overlap each other. This ground pattern may be connected to the ground at all times regardless of the driving signal to block the noises of the display introduced into the sealing line.

For convenience of the description in the current embodiment, this embodiment may reflect improvements of the third embodiment. As such, descriptions that are duplicative of the third embodiment will be omitted for the sake of brevity.

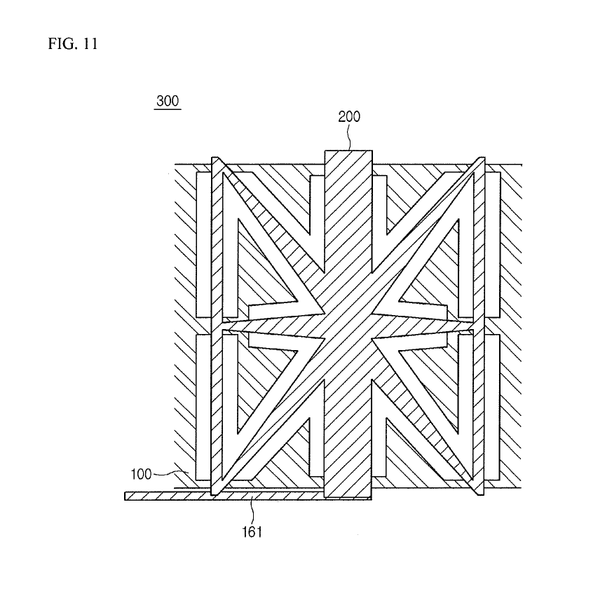

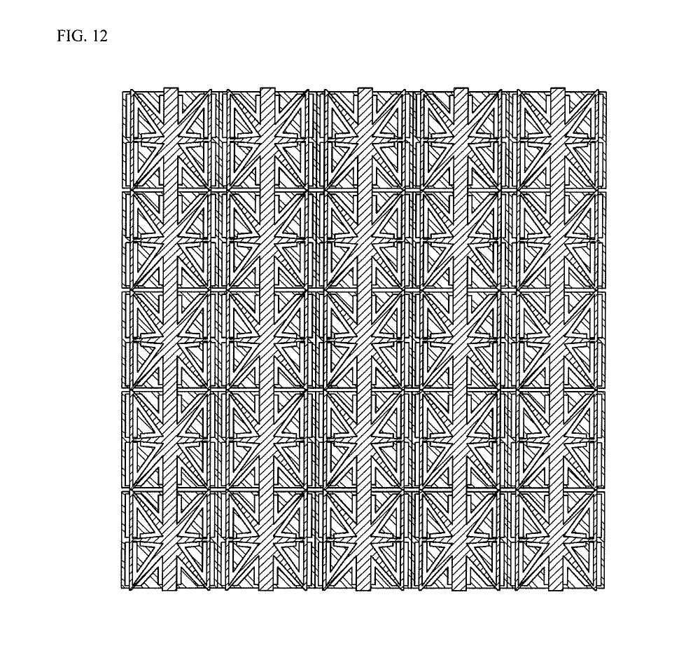

FIG. 10 is a plan view illustrating a pattern of a driving line in a single pixel in accordance with a fourth embodiment. FIG. 11 is a plan view of the driving line and a sensing line in the single pixel in accordance with the fourth embodiment, and FIG. 12 is a plan view of driving lines and sensing lines in a plurality of pixels of FIG. 11 in accordance with the fourth embodiment.

A sensing line 200 in accordance with the current embodiment has the same shape as the sensing line pattern in accordance with the third embodiment.

Referring to FIGS. 10 to 11, the driving line 100 may have holes that surround areas in which the driving line 100 and the sensing line 200 overlap each other. Also, the driving line 100 may include a driving area 170 to which the driving signal is applied, a ground pattern 160 that partially overlaps the sensing line 200, and a ground line 161 for electrically grounding the ground pattern 160.

In more detail, the driving line 100 may be a bar-type transparent electrode. The driving line 100 may be spaced by a predetermined distance downward from the sensing line 200 to extend in a direction (e.g., an X-axis direction) crossing the main line 210.

The holes of the driving line 100 may be defined around the areas which overlap the sensing line 200 to improve fringing capacitance. The ground pattern 160 may overlap a portion of the sensing line 200 and be electrically isolated from the driving area 170 by the holes. That is, as illustrated in FIG. 10, the holes may be defined to surround the ground pattern 160.

For example, the ground pattern 160 may correspond to the main line 210 and the first, second, and third branchlines 231, 232, and 233 of the sensing line 200 and be electrically grounded through the ground line 161. Particularly, a first noise blocking pattern 141 and a third noise blocking pattern 143 which are illustrated in FIG. 9 may be used as the ground pattern 160. In this case, the first noise blocking pattern 141 and the third noise blocking pattern 143 may be electrically isolated from the driving area 170 and connected to the ground line 161.

As a result, since the ground pattern 160 is connected to the ground regardless of the driving signal, the introduction of the noises from the display 10 into the sensing line 200 may be restricted. A distance between the driving area and the sensing line 200 may be sufficiently secured to sufficiently improve the fringing capacitance.

As illustrated in FIG. 11, the sensing line 200 corresponds to the ground pattern 160 of the driving line 100. As illustrated in FIG. 12, the ground patterns 160 of the plurality of pixels are connected to the ground through the ground lines 161.

Thus, the introduction of the noises from the display 10 into the sensing line 200 may be sufficiently blocked, and also, parasitic capacitance may be reduced so as to improve touch sensitivity.

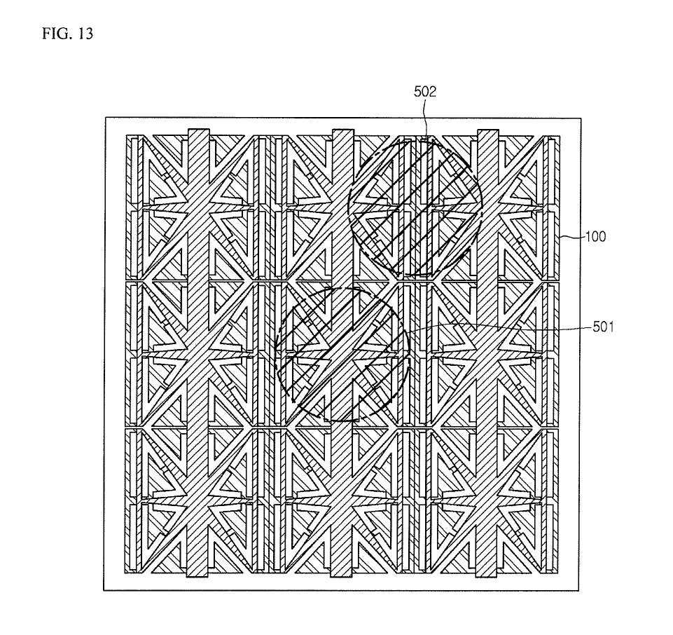

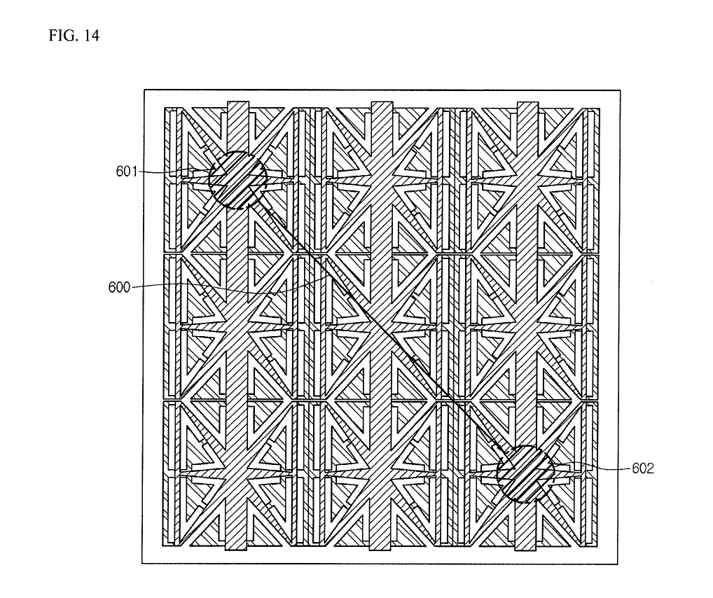

Hereinafter, the advantages of some embodiments will be described with reference to FIGS. 13 and 14. FIG. 13 is a view for explaining a variation in mutual capacitance when a specific position on a touch panel is touched in accordance with the third embodiment, and FIG. 14 is a view for explaining a variation in mutual capacitance when a touch pattern traveling in a diagonal direction is inputted on the touch panel in accordance with the third embodiment.

Referring to FIG. 13, nine pixels in accordance with the third embodiment are provided, and two touches 501 and 502 are inputted on the pixels.

First, the first touch 501 may be touched so that one pixel region disposed at the center of the depicted area is selected. Here, the sensing line according to the current embodiment may have a circumferential length, which is greater than that of the general bar-type sensing line, and the holes to increase an amount of fringing capacitance. Thus, it is predicted that a large amount of mutual capacitance varies when touched. Thus, the sensing part may more accurately detect the variation in mutual capacitance to thereby improve the touch sensitivity.

The second touch 502 may be touched on a boundary between the pixels. In this case, since the sub lines of the sensing line are disposed on the boundary in the current embodiment, the mutual capacitance of both pixels may increase in variation. As a result, the sensing part may accurately detect the touched point between both pixels.

Referring to FIG. 14, nine pixels in accordance with the third embodiment are provided, and touch patterns 600, 601, and 602 that are dragged by the user in a diagonal direction are inputted. When a touch region is away from a specific pixel by movement of the user touch, it is seen that the sensing line included in the touch region decreases in area. Thus, it is predicted that the mutual capacitance is linearly reduced. Thus, it is seen that the sensing part may measure the linear variation of the mutual capacitance to thereby accurately detect the touch patterns.

According to the embodiments of the present invention, the noise blocking pattern may be disposed in the region in which the driving line and the sensing line overlap each other. The holes may be defined around the noise blocking pattern to thereby prevent the noises from being introduced into the sensing line from the display, and further thereby relatively increasing the fringing capacitance.

The noise blocking pattern may be electrically grounded, and thus, the parasitic capacitance may be relatively reduced between the driving line and the sensing line.

As a result, when the conductor is touched on the touch panel, the mutual capacitance may increase in variation. Therefore, the touch panel may be significantly improved in touch sensitivity.

In addition, as the mutual capacitance increases in variation, the touch panel may be sufficiently reduced in thickness.

Although the touch panel and touch screen having been described with reference to the specific embodiments, embodiments of the invention are not limited thereto. Therefore, it will be readily understood by those skilled in the art that various modifications and changes can be made thereto without departing from the spirit and scope of the present invention defined by the appended claims.

What is claimed is:

1. A touch panel for recognizing touch of a conductor, the touch panel comprising:
a driving line extending in a first direction; and
a sensing line disposed over the driving line to extend in a second direction crossing the first direction,
wherein the driving line defines one or more holes that are formed in both sides of a region in which the driving line and the sensing line overlap each other, and wherein the driving line comprises a noise blocking pattern corresponding to a bottom surface of the sensing line in the overlapping region.

2. The touch panel of claim 1, wherein the one or more holes have a width of approximately 200 μm.

3. The touch panel of claim 1, wherein the sensing line comprises a main line extending in the second direction, a sub line spaced by a predetermined distance from a side of the main line to extend in the second direction, and a branch line connecting the main line with the sub line.

4. The touch panel of claim 3, wherein the noise blocking pattern comprises a first noise blocking pattern corresponding to the main line, a second noise blocking pattern corresponding to the sub line, and a third noise blocking pattern corresponding to the branch line, and wherein the one or more holes are formed in both sides of the first, second, and third noise blocking patterns.

5. The touch panel of claim 4, wherein the driving line comprises a bridge pattern connecting a region that is isolated by the one or more holes with at least one of the first, second, and third noise blocking patterns.

6. The touch panel of claim 4, wherein at least one of the first, second, and third noise blocking patterns is electrically isolated from the driving line and electrically grounded through a ground line.

7. The touch panel of claim 1, further comprising a driving part for applying a driving signal to the driving line and a sensing part for detecting mutual capacitance varying by the touch to calculate a touch coordinate.

8. A touch screen for recognizing touch of a conductor and outputting an image, the touch screen comprising:
a display;
a driving line disposed over the display to extend in a first direction; and
a sensing line disposed over the driving line to extend in a second direction crossing the first direction,
wherein the driving line defines one or more holes that are formed in both sides of a region in which the driving line and the sensing line overlap each other, and wherein the driving line comprises a noise blocking pattern corresponding to a bottom surface of the sensing line in the overlapping region.

9. The touch screen of claim 8, wherein an optical clear adhesive layer is disposed between the driving line and the sensing line.

10. The touch screen of claim 9, wherein the sum of thicknesses of the driving line, the optical clear adhesive layer and the sensing line is less than approximately 40 μm.

11. The touch screen of claim 9, wherein the optical clear adhesive layer comprises an insulation material.

12. A touch panel for recognizing touch of a conductor, the touch panel comprising:
a driving line extending in a first direction; and
a sensing line disposed over the driving line to extend in a second direction crossing the first direction,
wherein the driving line comprises a ground pattern disposed in a region in which the driving line and the second line overlap each other, and at least one hole is formed to surround the ground pattern.

13. The touch panel of claim 12, further comprising a ground line connected with the ground pattern, the ground line electrically grounding the ground pattern.
